(19) United States
(12) Patent Application Publication
(10) Pub. No.: US 2010/0088241 A1
(43) Pub. Date: Apr. 8, 2010

(54) INTEGRATED SYSTEM FOR MONITORING WORK FLOW IN AN ORGANIZATION

(75) Inventor: Dan Phillips, Austin, TX (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: INTERNATIONAL RAM ASSOCIATES, Chantilly, VA (US)

(21) Appl. No.: 12/546,388

(22) Filed: Aug. 24, 2009

Related U.S. Application Data
(60) Provisional application No. 61/091,152, filed on Aug. 22, 2008.

(51) Int. Cl. G06Q 10/00

(52) U.S. Cl. 705/301

(57) ABSTRACT

A method of controlling workflow through a variety of departments in the organization each of which has different functions and responsibilities with regard to the completion of a program or project. The method, and program by which the method is implemented, monitors work related activities to assist personnel in coordinating the workflow within each department with that in the other departments. The program by which the method is implemented is designed to manage workflow activities and govern them in such a way that mistakes are substantially eliminated. This is accomplished by eliminating the need for repetitive entries of the same information, thus minimizing the workload of managing information within each department.

### CROSS REFERENCE TO RELATED APPLICATIONS

This application claims priority to U.S. Provisional Application No. 61/091,152 filed on Aug. 22, 2008, of which is herein incorporated by reference.

### STATEMENT REGARDING FEDERALLY SPONSORED RESEARCH

Not Applicable.

### BACKGROUND OF THE INVENTION

This invention relates to the control and oversight of workflow in a business; and, more particularly, to a method for integrating the activities simultaneously occurring in various departments within an organization and providing department personnel and management a comprehensive overview of workflow throughout the organization.

Programs carried by an organization typically require the co-ordination and co-operation of a variety of departments. A comprehensive list of such departments would include purchasing, sales, logistics, inventory and warehousing, engineering, research and development, planning, manufacturing, quality control, documentation, field services, accounting, human resources, and management. It is not uncommon for any organization of reasonable size to be simultaneously engaged in a number of programs each of which is requires activities which involve participation from most, if not all, of these departments. It will be appreciated that some programs will require more input from a particular department than other programs will, and that each program will proceed according to a different schedule so that the timing of each department's involvement will vary. It will be further appreciated that for sophisticated programs, each department will probably be continually involved throughout the life of the program with a particular department's involvement being greater at certain times than at others.

The ability to manage the progress of a program as it progresses from start to finish; and in particular the work flow through of the departments involved has always presented a significant challenge for organizations. Scheduling issues, lead times for acquiring resources (people, material, work space) has always been complicated. Delays occur. Unforeseen situations arise and most be dealt with. Budgetary considerations cause changes to have to be made. Customers change their minds and now want this instead of, or in addition to, that. Regulations change or new regulations are imposed. All of these affect any program and how it progresses. But, in the end, a product or service must be provided to a customer (either external or internal to the organization) and done so with the organization making a profit (or, at least, not losing money).

Over time, various programs or methods have been employed, often in combination, to enable employees and management to understand and deal with the workflow through an organization so that a program is successfully completed, preferably on-time and under budget. Such methods as PERT, Just-In-Time purchasing and manufacturing are but two examples of techniques companies have employed. Now, with the prevalency of the internet, WAN and LAN systems, etc. organizations, even those widely dispersed, have the ability for departments to rapidly communicate with each other and share information about the flow of work through their departments.

While the recent advances in technology of assisted organizations in having more up-to-date information about what is going on in the aforementioned departments this has not resulted in the better control of work flow and co-ordination between departments that one would have expected. The method of the present invention, sold under the trade name RAMnet™, addresses the deficiencies found in current programs being used to improve the control of work flow and make organizations even more efficient in developing products and services for their customers.

### BRIEF SUMMARY OF THE INVENTION

The present invention is directed to a method of controlling the workflow through an organization and, in particular, through a variety of departments within the organization each of which has different functions and responsibilities with regard to the completion of a program or project. The method, and program by which the method is implemented, oversees group work related activities and operates to co-ordinate the workflow of each department within an organization with that of the other departments so that each department's activities “dovetail” with those of other departments. In this regard, the method of the invention provides ability to match the actual process of work carried out throughout the organization, and not the other way around. The program by which the method is implemented is designed to manage workflow activities and govern them in such a way that mistakes are significantly if not completely eliminated. This is, in part, accomplished by eliminating the need for repetitive entries of the same information, thus minimizing the workload of managing information within each department.

The program employs a FileMaker® pro engine as its database system; or, instead, the user can obtain the requisite information needed via the Internet using an appropriate browser. Use of the program enables an organization to get an accurate assessment of the work flow in each department and, department modules can be modified if necessary.

Finally, it is an object of the invention that the method and the program by which it is implemented are easy to use and that the program has a very short learning curve for people using it.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a flowchart illustrating implementation of the process of the present invention;

FIG. 2 is illustrates an information flow network;

FIG. 3 is a flowchart illustrating what is tracked by the process;

FIG. 4 is a flowchart for sales order processing;

FIG. 5 is a flowchart for the processing of purchase orders;

FIGS. 6A-6P are representative computer screen displays for different aspects of the process; and,

FIGS. 7A-7E are representative screen displays for tracking a project which integrates various of the activities associated with the screen displays of FIGS. 6A-6P.

Corresponding reference characters indicate corresponding parts throughout the several views of the drawings.

### DETAILED DESCRIPTION OF THE INVENTION

In a business organization, “workflow” can be defined as a reliably repeatable pattern of activity that is enabled by the systematic organization of resources, defined roles, and information and energy flow into a work process that can be documented and learned. Workflows are almost always designed to achieve processing intents of some sort. This includes such things as the physical transformation of various components or parts into a product which is used or sold; the provision of some type of service; or, the processing of information. Workflow is closely associated with other concepts used to describe organizational structures; such as, functions, teams, projects, policies and hierarchies. Workflows are, in effect, the building blocks of an organization.

The RAMnet™ process of the present invention is designed to manage workflow activities and govern them in such a way that mistakes are reduced by the elimination of the need to repetitively enter the same information; thus, minimizing the workload of managing information within each department within the organization. RAMnet™ operates by using a FileMaker® pro engine which was selected for its versatility and robust nature when handling large amounts of data as the database system for operations. The RAMnet™ system is designed to work with each department within an organization and to function as a “team member” with the people within each department responsible for entering data into the system.

Importantly, the RAMnet™ system provides the capability of integrating everything needed for tracking a project into a single environment. The system is easy to use, provides an analysis capability so management can readily determine a program's status, and can track a project at different task and responsibility levels. Further, the system enables anyone within an organization to record and track a project of any size or type. The system's reporting module gives the user the ability to look at the project in detail, or just an overview.

Accordingly, and as described hereinafter, the method described controls workflow in the organization by identifying critical information required by each department within the organization for controlling the work flow through that department. Next, information within each department useful to other departments for controlling the work flow through that department and coordinating the workflow through the department with the workflow through each of the other departments is identified. Finally, the method of the invention provides an information framework by which all the identified information is readily available, as needed, throughout the organization so to facilitate implementation of those work flow activities required of each department to efficiently complete an organizational activity.

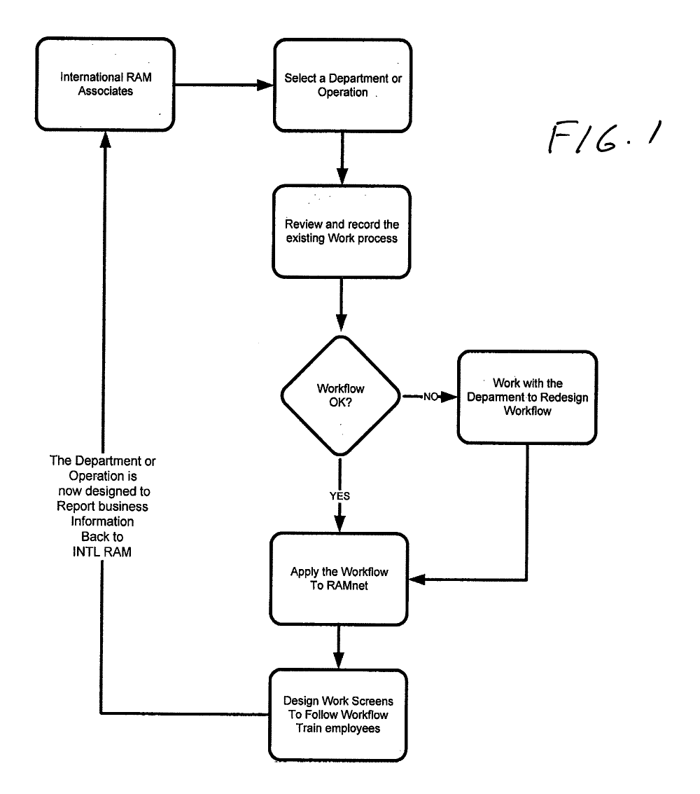

Referring to FIG. 1, in implementing the system, a department or operation is selected. For that department or operation, the existing work flow or process reviewed and a record is made of it. If, based upon the review, it is determined that the work flow process is acceptable, the process is incorporated into the system's template for entering information into the system and tracking work flow within that department or operation. If it is decided, however, that current work flow tracking is deficient, then those responsible for implementing the process work with the responsible department or operation's personnel to devise a better work flow pattern which is now incorporated into the system. Once the work flow pattern of this department or operation is complete, computer work screens are designed to help track the work flow and train employees about use of the system in their area of responsibility. During this stage it is advisable that each employee involved have an input as to how the screens are developed, their look, their entry fields, and reporting mechanisms. This gives them “ownership” of the system and creates a desirable reason for them to enter the correct data on a consistent basis. Once the screens are developed, the completed module is integrated into the overall system which, when fully implemented, is completely available to each department or segment of the operation, regardless of their geographical location.

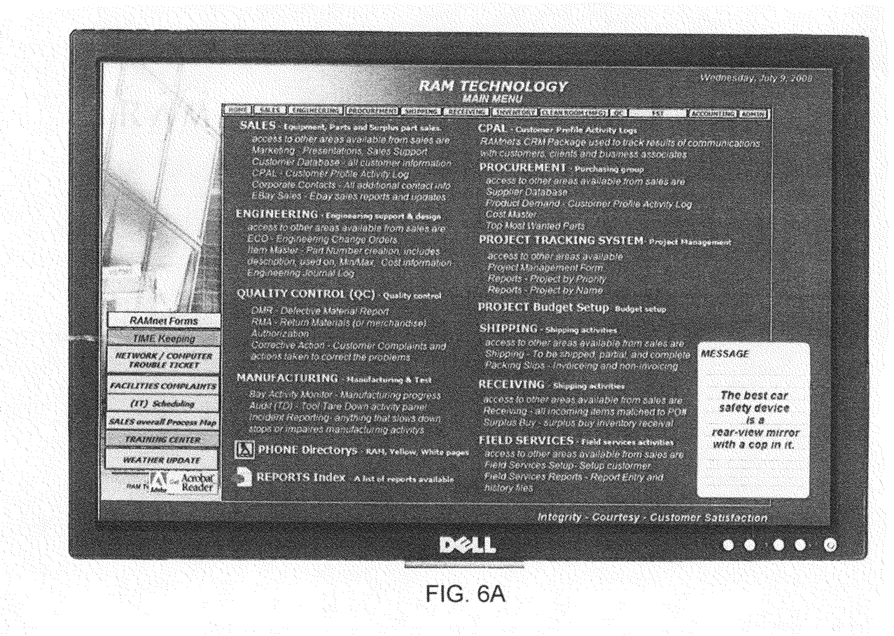

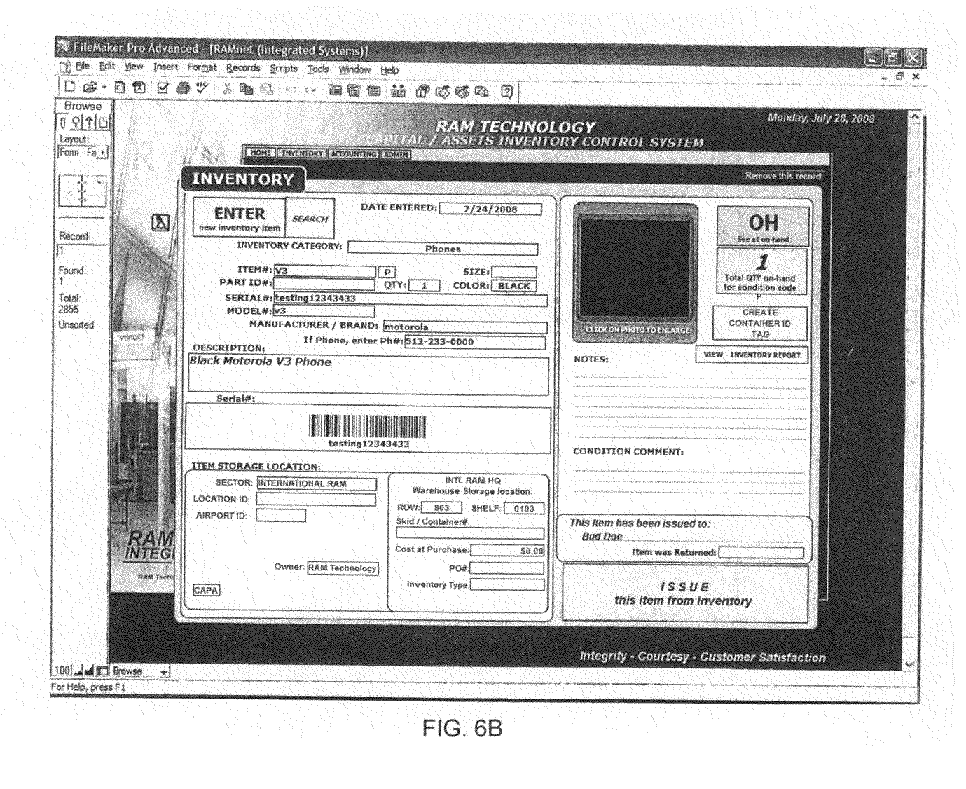

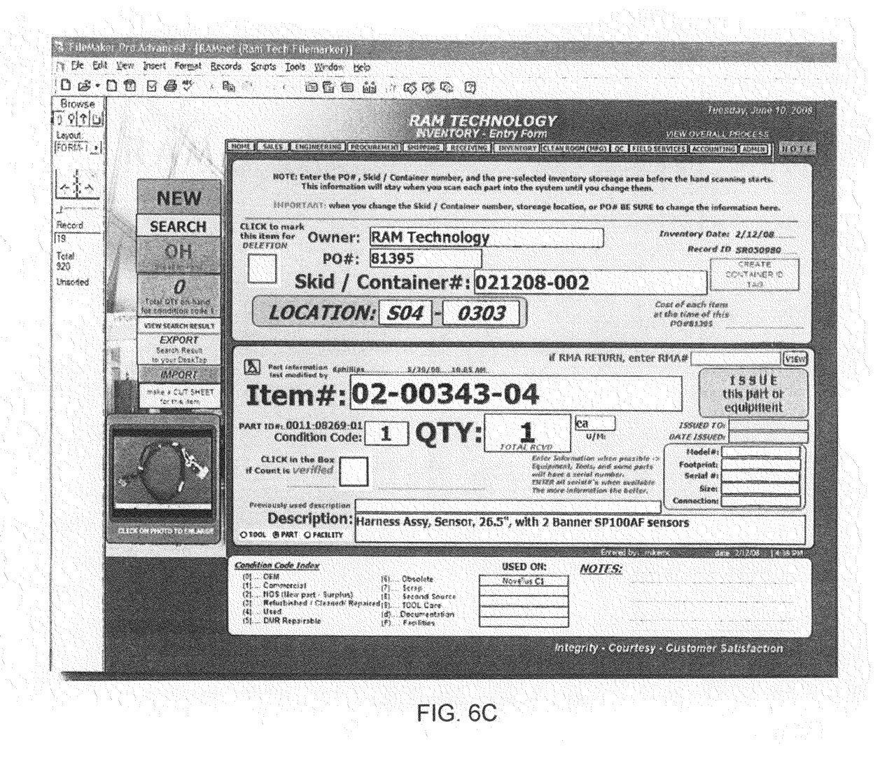

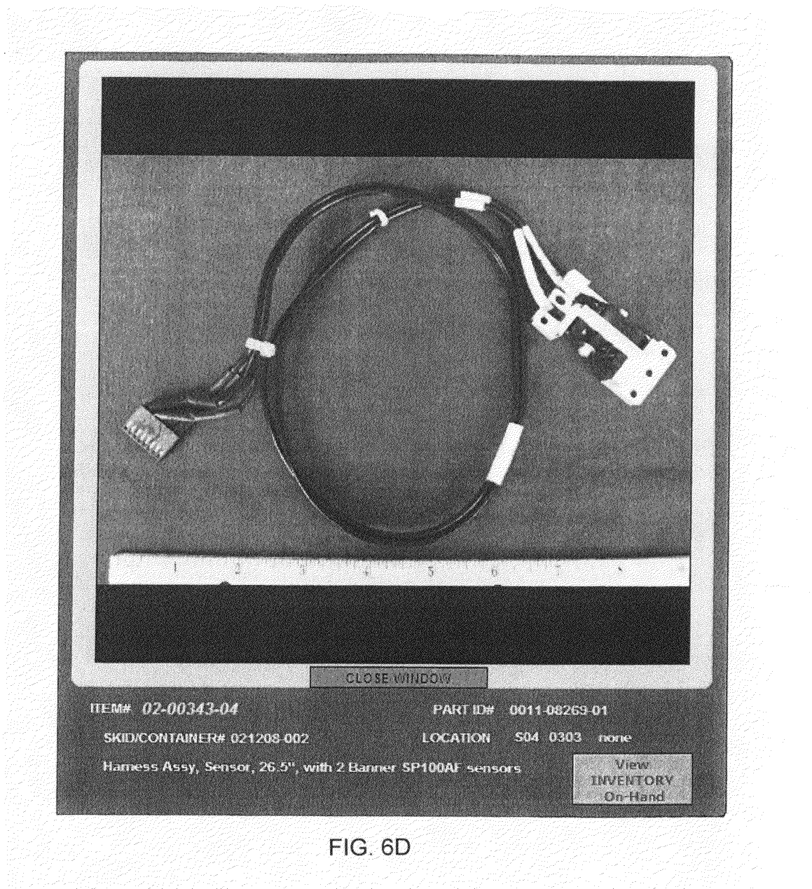

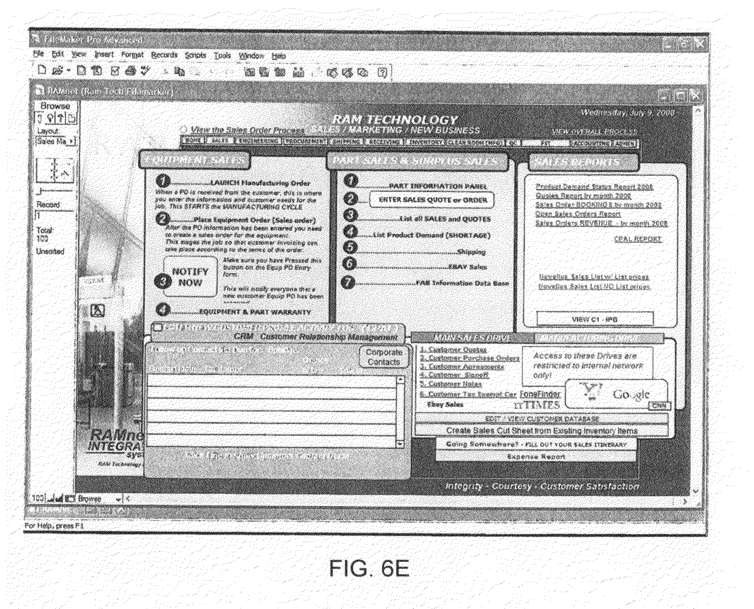

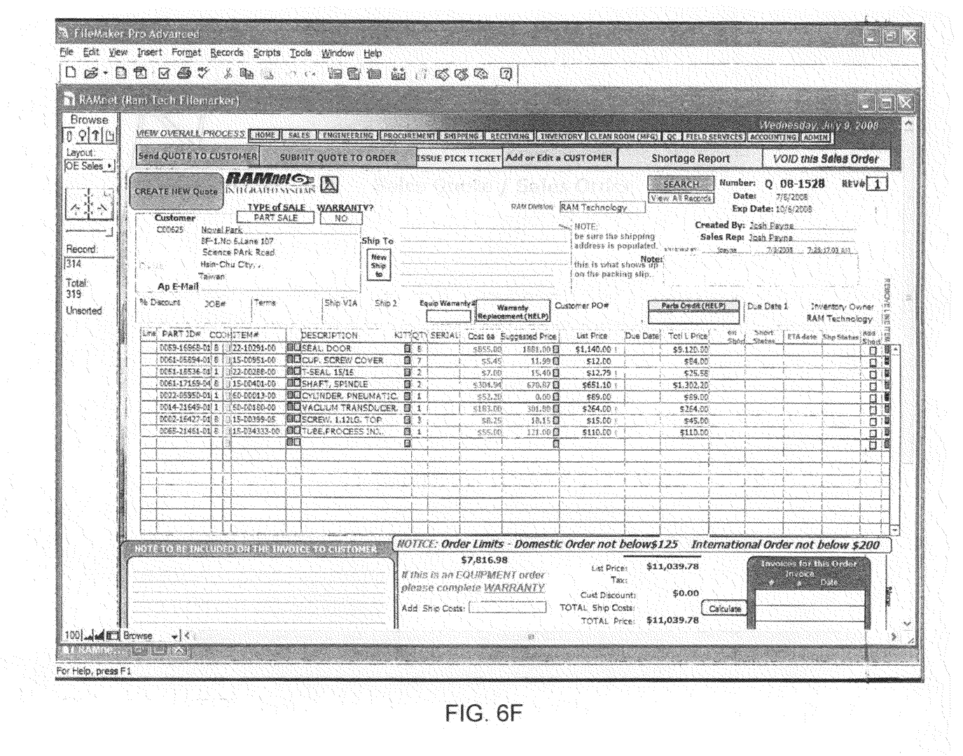

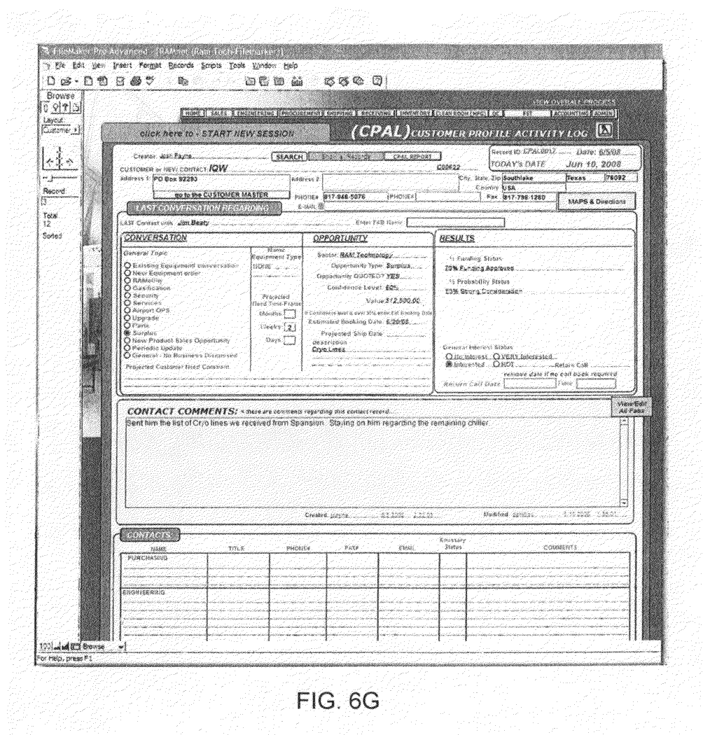

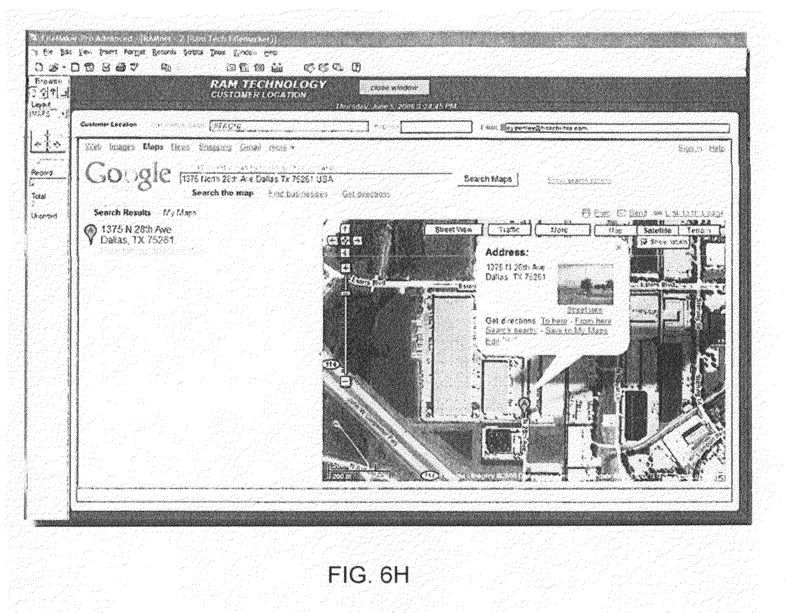

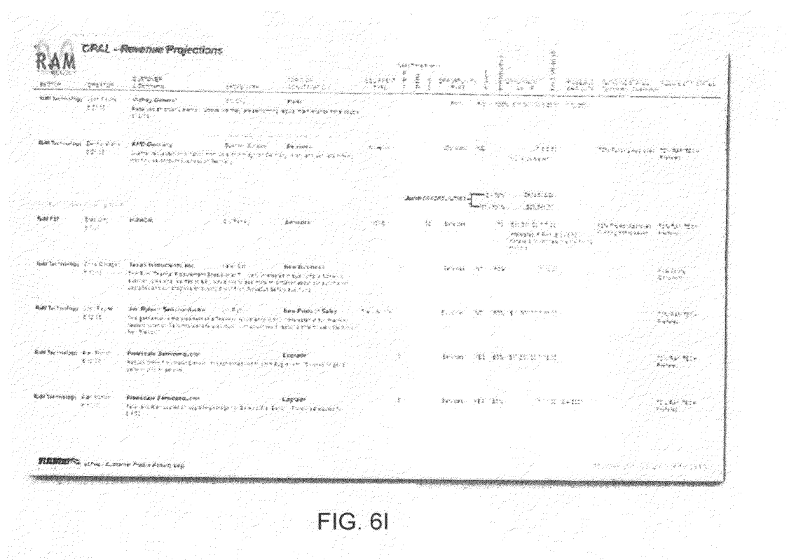

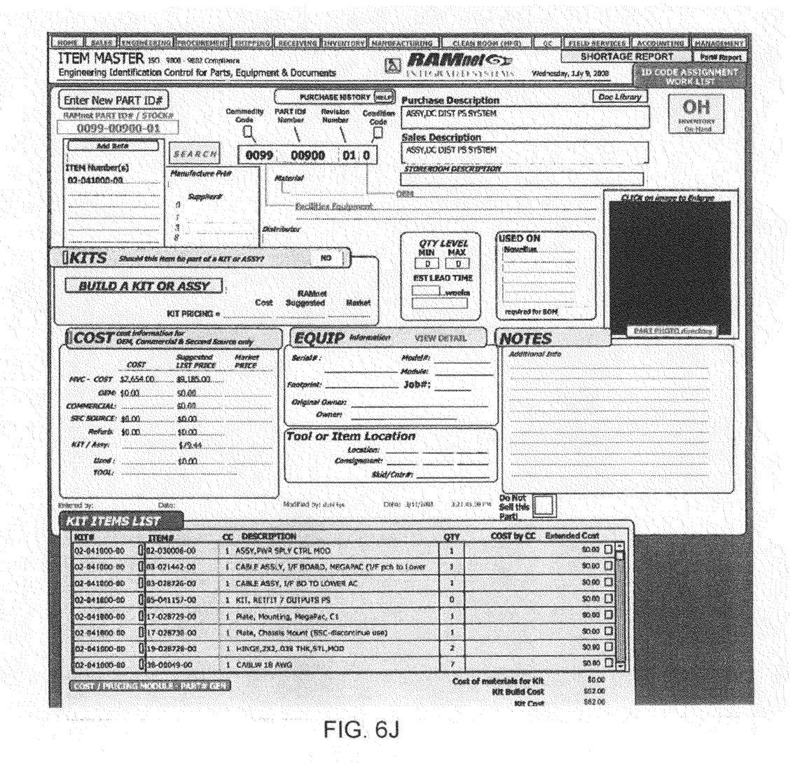

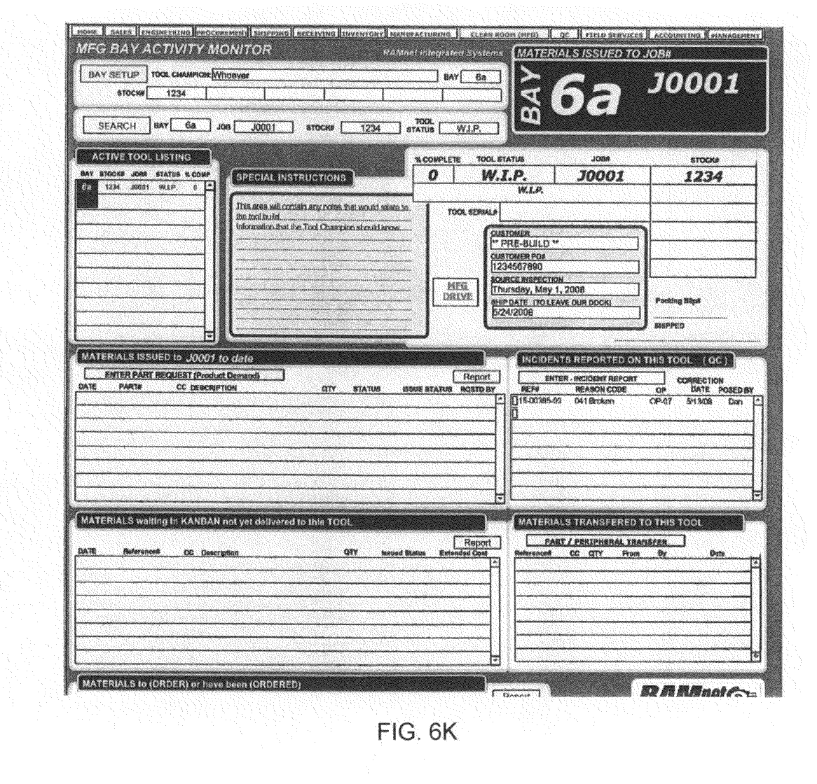

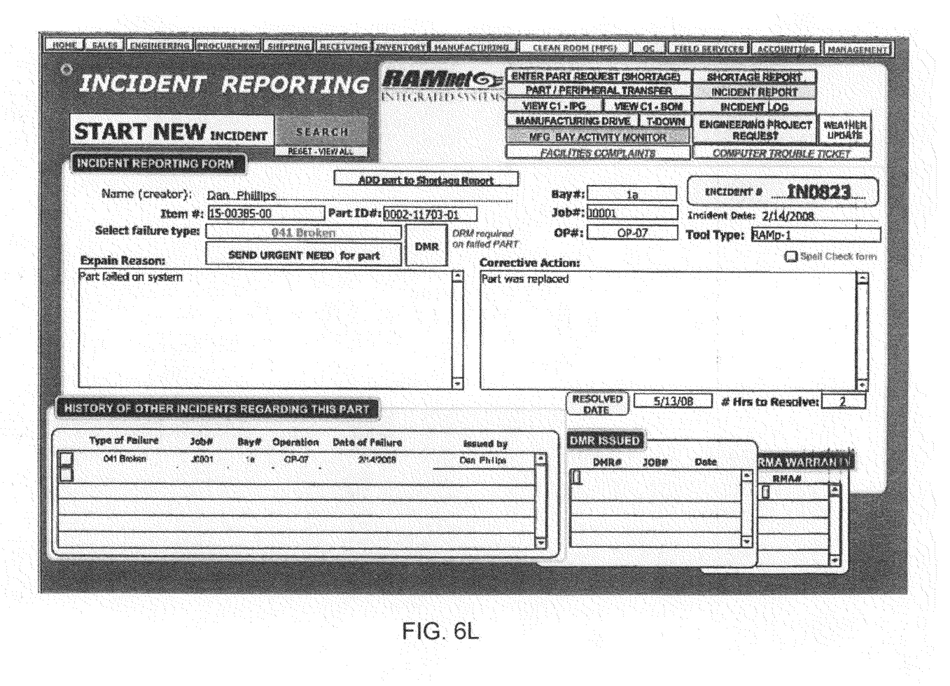

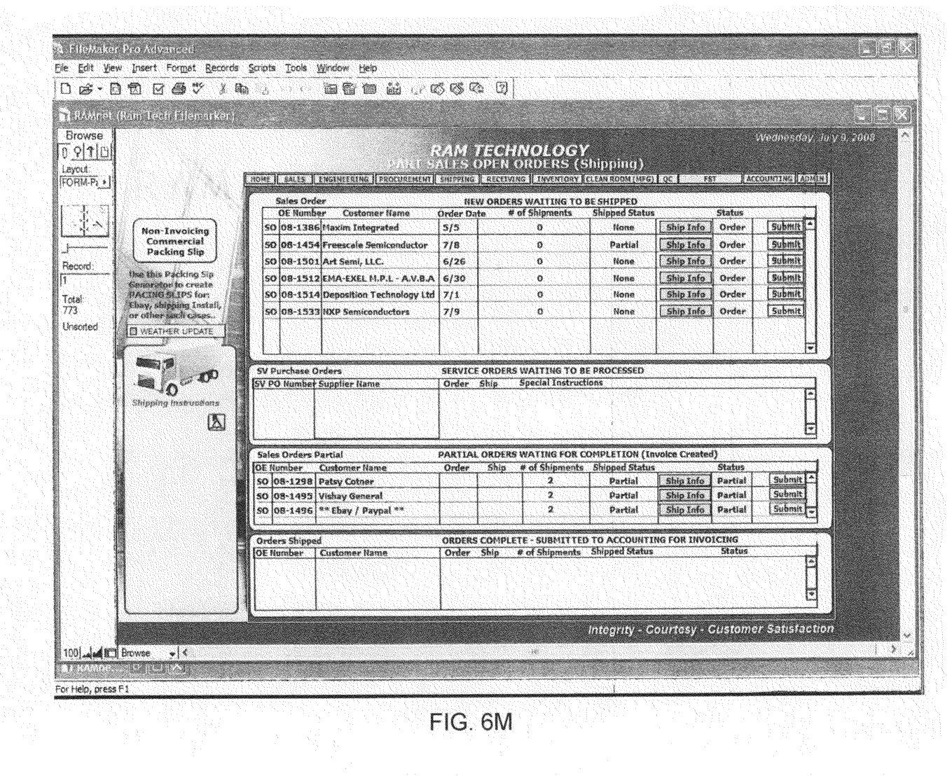

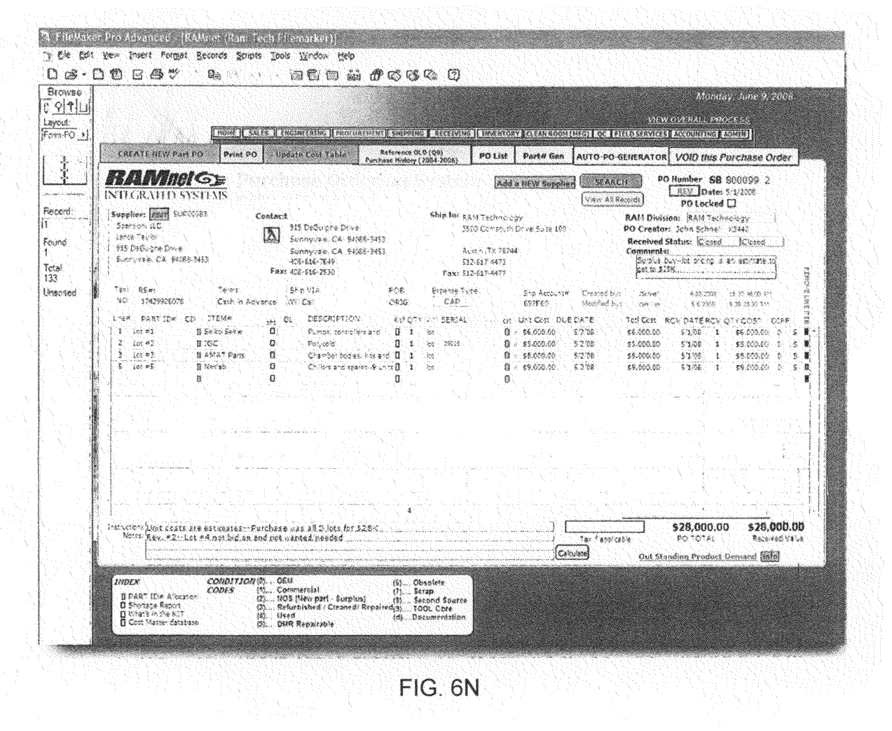

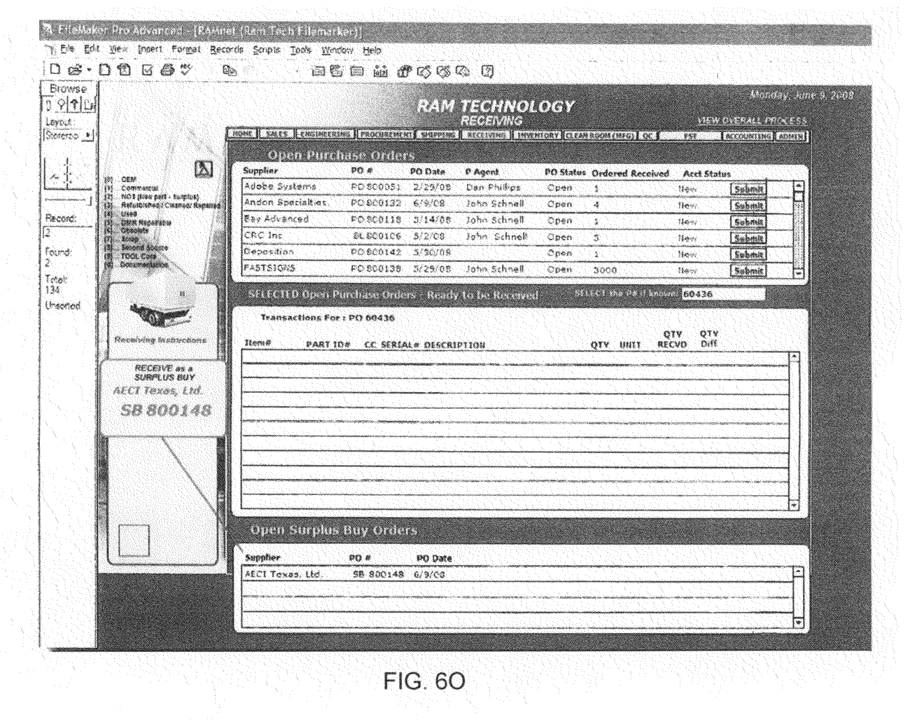

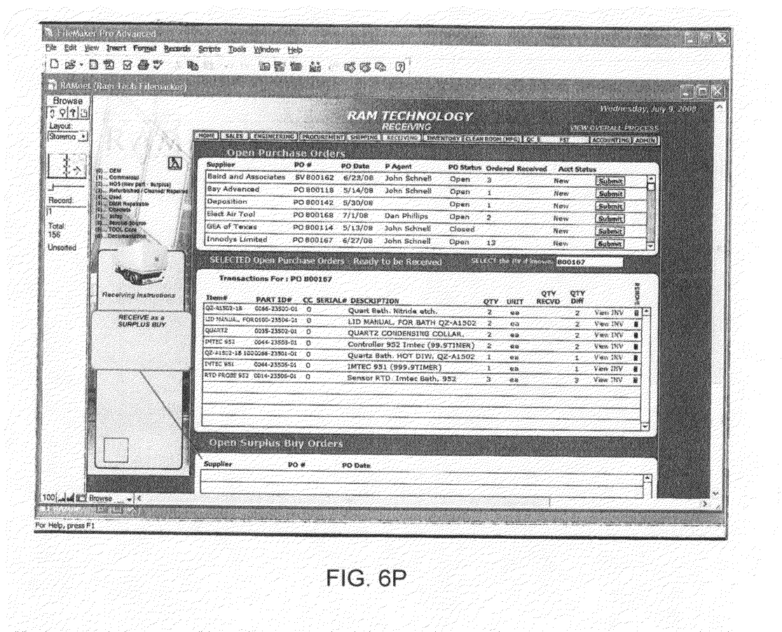

As shown in FIG. 6A, the main menu for the program lists the various departments integrated into the system and information associated with each department. The menu is presented so as to be easy to read and understand.

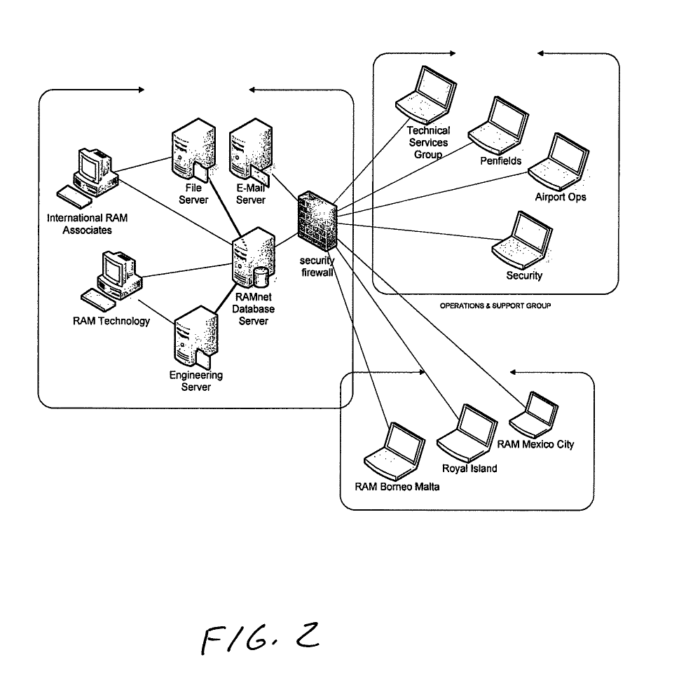

Referring to FIG. 2, the communications network for system implementation is shown to include a central communications operation through which information is directed to and from different departments of operations through a security firewall. Communications can be via the Internet using an appropriate browser, a local area network (LAN), a wide area network (WAN), or a combination of these. Those skilled in the art will appreciate that the network shown in FIG. 2 can be reconfigured as new departments or operations are added or deleted.

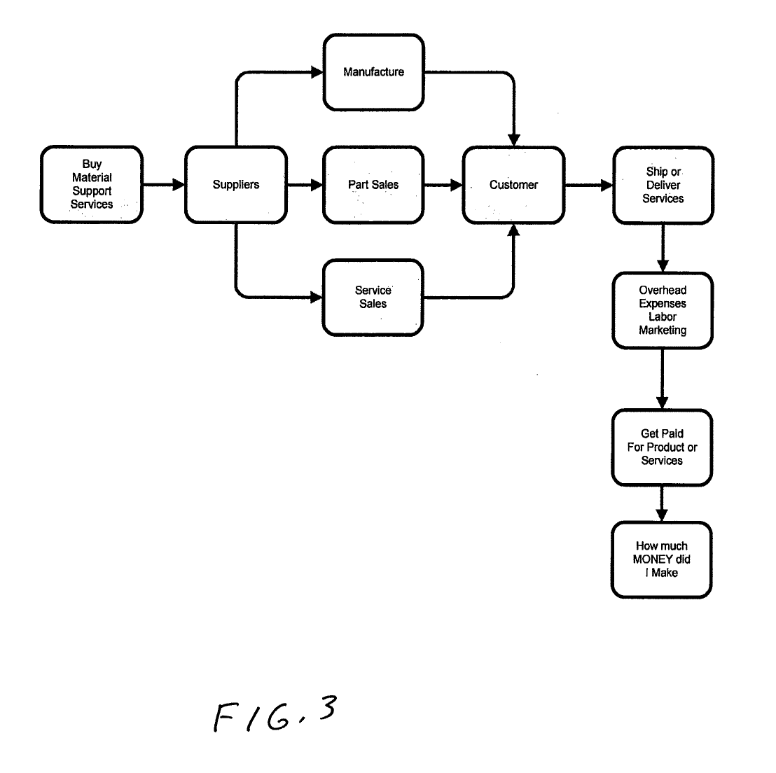

As shown in the flowchart of FIG. 3, an organization uses its resources to buy material to manufacture a product, or obtain resources to provide or support a service. The resources expended by the organization go to suppliers who manufacture a product which is sold to a customer, make or acquire parts which are sold to the customer, or to sell a service to the customer. The expenses involved in these activities include the costs of shipping the product or delivering the services, as well as direct and indirect overhead expenses, labor costs, and marketing costs. These costs, once deducted from the revenues received for sale of the product or service revenues determine how much money the organization makes.

As to information available using the system, with respect to inventory, FIG. 6B represents the screen display for a fully integrated inventory control system. FIG. 6C is a screen presentation for a particular item of inventory, it being understood that each separate item of inventory is listed on a separate screen. In addition to the individual listing, an image (photograph) the particular item can also be displayed as shown in FIG. 6D.

Concerning sales, FIG. 6E represents the screen display for reporting sales and new business activity, and FIG. 6F the screen display for entering sales orders. FIG. 6G represents a customer profile activity log screen display for use in customer resource management or CRM. This screen is used by a sales person when, for example, they are speaking on the telephone with a customer. It is also used in identifying sales leads, customer contacts or accounts, for marketing activities, and identifying sales opportunities and providing quotes and doing sales forecasts. If a salesperson is going to visit a customer a map display such as shown in FIG. 6H will facilitate getting to the customer's location.

Further with regard to sales, FIG. 6I illustrates a screen display for use in projecting sales revenues. As shown in FIG. 6I, the projections are sorted by estimated booking dates. The report of FIG. 6I, provides a breakdown of quoting opportunities for customers and clients. A Confidence level factor is shown assigned to each separate opportunity. As shown, there is a two-level breakdown:

a. from 0%-79% and the total Quoted value; and

b. to 80%-100% and the total Quoted value.

Although not shown in FIG. 6I, at the end of the report there is a computed grand total for all the listed opportunities. The report is sorted by business sector, and includes a calculation of the opportunities by their estimated booking date. The report enables management to assess projected opportunities for a given period (e.g., each month) and to date, based on percentages of expectations for the booking dates. Other reports provide the information by customer or client. Still other reports provide monthly revenues forecasts based on this information.

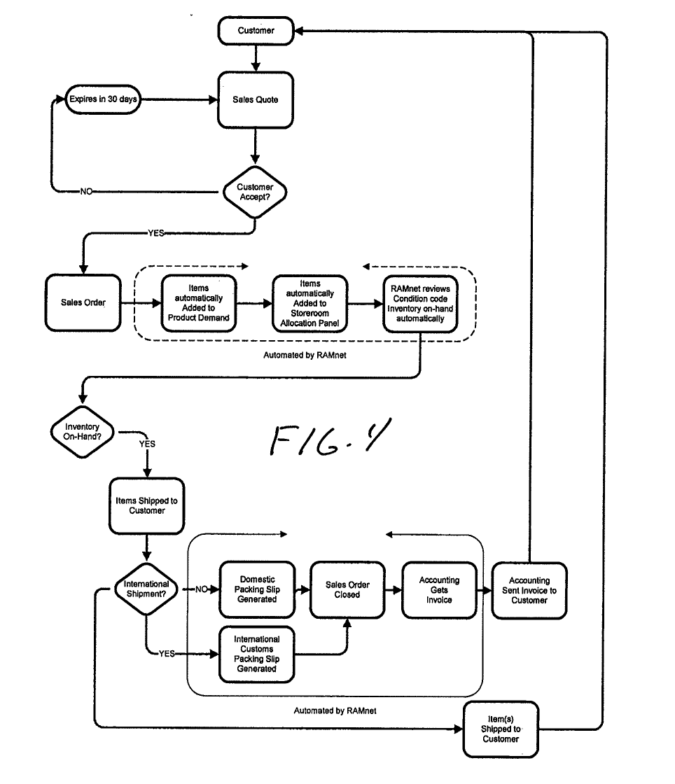

With respect to sales, the work flow tracked using the system of the present invention is shown in FIG. 4 where a customer is initially provided with a price quote which is typically good for a specified period of time (e.g., 30 days). If the customer accepts the quote, a sales order is generated for production of the product or delivery of the service.

Generation of the order then automatically results in the system adding items to the list of those required to make the products so the appropriate amount of material and parts are available to meet demand. This list of items is automatically added to the storeroom allocation list so the appropriate items (and their number or amount) are pulled from inventory and delivered to the manufacturing site. At the same time, the inventory status of these items is checked to determine if adequate inventory is on-hand, or more parts must be ordered. For this purpose, FIG. 6J is a screen display for a master list of materials required in the manufacture of the product. As shown in FIG. 3, each of these activities are automatically carried out by the system, and the work flow associated with these activities is monitored by the system so that production activities can be properly scheduled so that production is not held up for that of parts, etc. In this regard, FIG. 6K represents a screen display for a manufacturing activity carried out in the making of a part pursuant to the order. FIG. 6L is a screen display used by the organization's quality control department as part of its quality assurance (QA) activities to insure the quality of the articles manufactured.

If the product is already in inventory, then the amount of inventory is automatically checked by the system to determine if there is sufficient inventory to ship the order to the customer. If there is sufficient quantity, then the product is shipped either to a domestic location of the customer, or to an overseas (i.e., international) destination. A shipping screen of the system is shown in FIG. 6M. Depending upon the destination, an appropriate packing slip is generated for the shipment. Once the product has been shipped and receipt by the customer has been verified, the sales order is closed by the sales department and the accounting department generates an invoice which is sent to the customer for payment. Again, operation of the system of the invention is such that all of these activities are automatically tracked and the various departments involved (sales, manufacturing, inventory control, shipping, accounting, etc.) can each access the relevant information about the order and see, from a work flow standpoint, exactly what is happening in the processing of the order. It will be understood by those skilled in the art that if a service rather than a product is being sold, the system similarly tracks those activities associated with providing the service and getting paid once it has been provided.

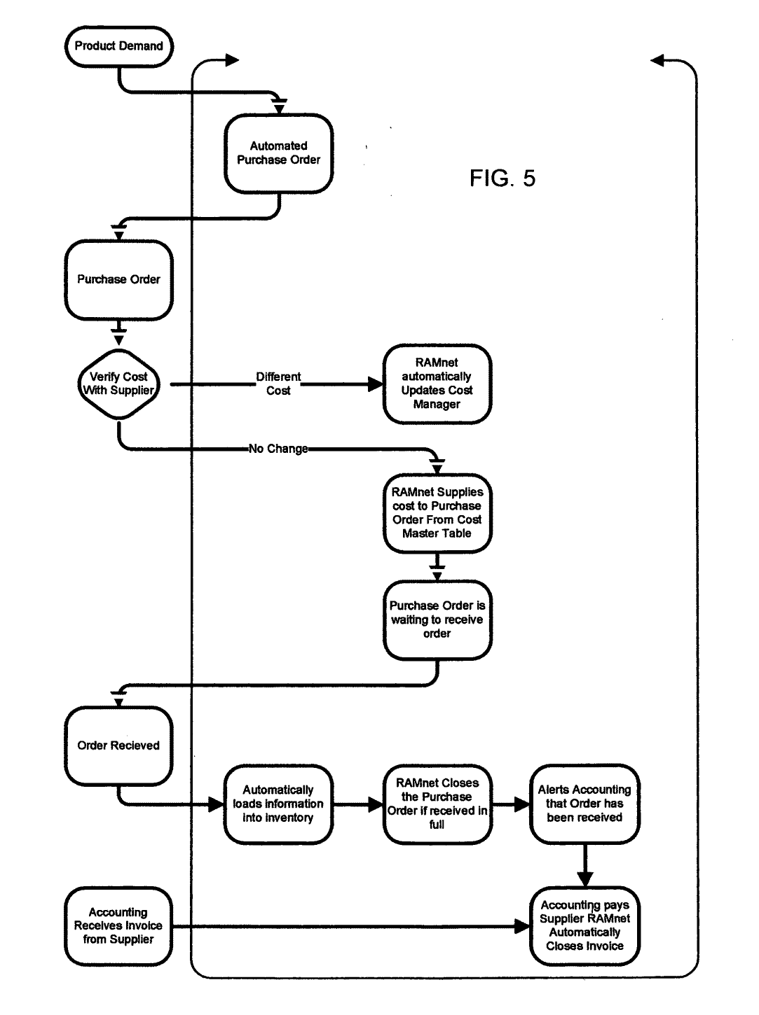

Referring to FIG. 5, the steps shown for handling of a purchase order (P.O.) includes generating a P.O. in response to demand for the product. The screen used for creation of a P.O. is shown in FIG. 6N. Once the P.O. is generated, supplier cost is verified and if there is a change in the cost from that currently in the system, the system is updated to reflect the new cost. All costs are maintained in a Cost Master database from which the information is extracted and applied to the purchase order. Once the P.O. is updated with the pricing information, it is held until an order for a product is received. Once an order is received, information from the order is used to update the inventory database. If there is sufficient inventory to satisfy the order, the P.O. is closed. Otherwise, the P.O. is issued to a supplier to acquire the material needed to produce the amount of product needed to satisfy the order. When the material or parts are received from the supplier, the inventory list is updated to show the new quantity of parts in the inventory system. FIG. 60 illustrates a receiving screen showing of the system on which newly received parts are displayed, and FIG. 6P illustrates a screen showing updated inventory. The supplier's invoice is directed to the accounting department so the invoice can be paid and the P.O. closed out.

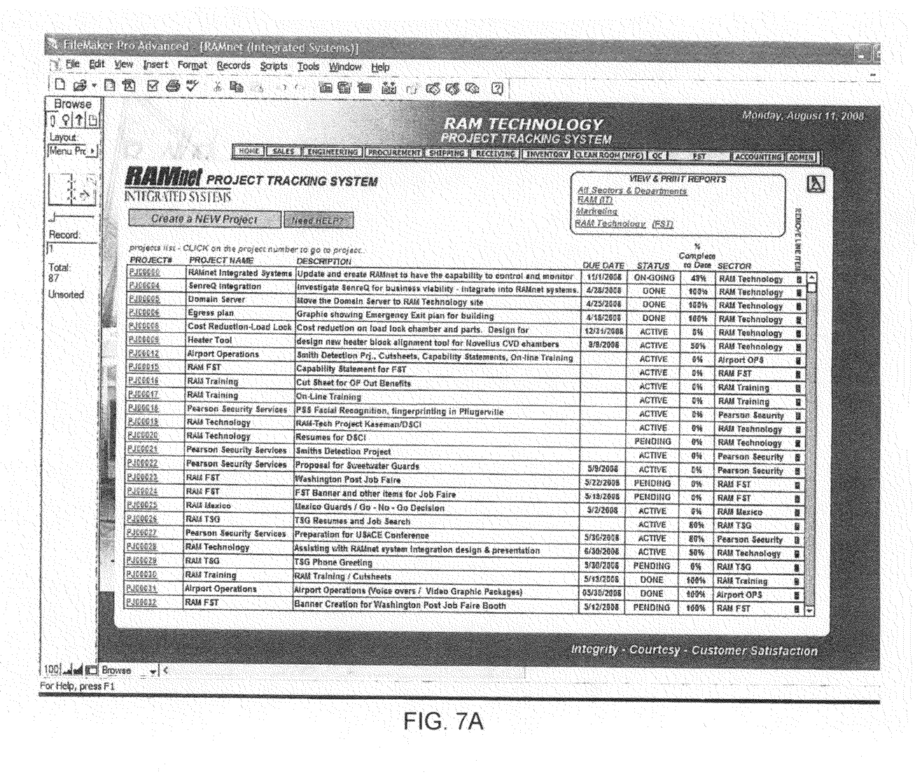

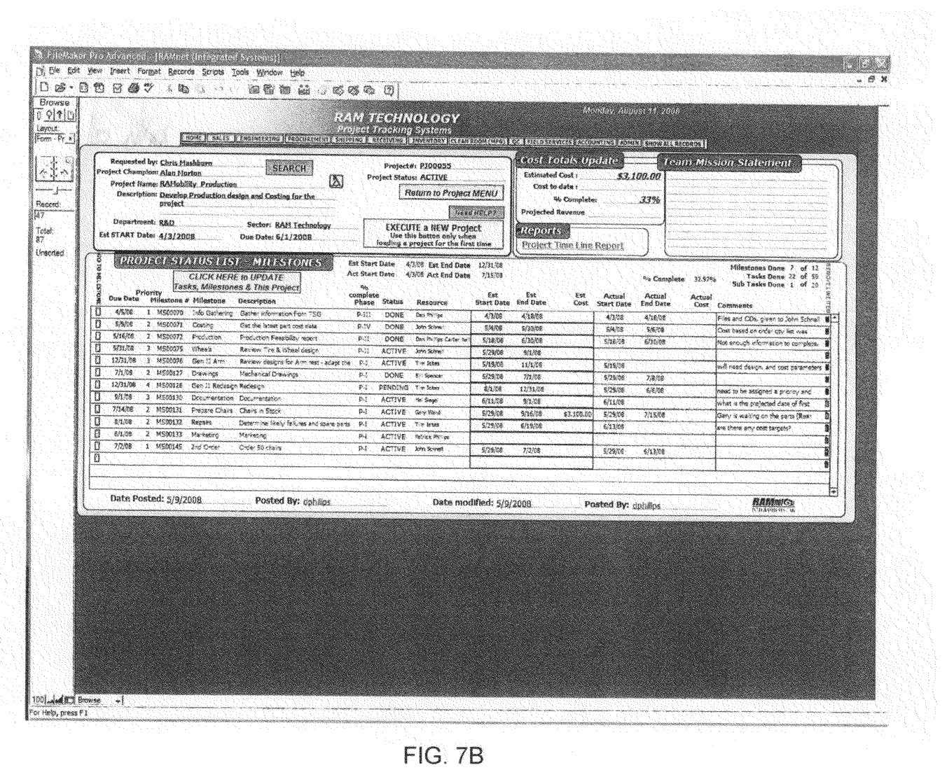

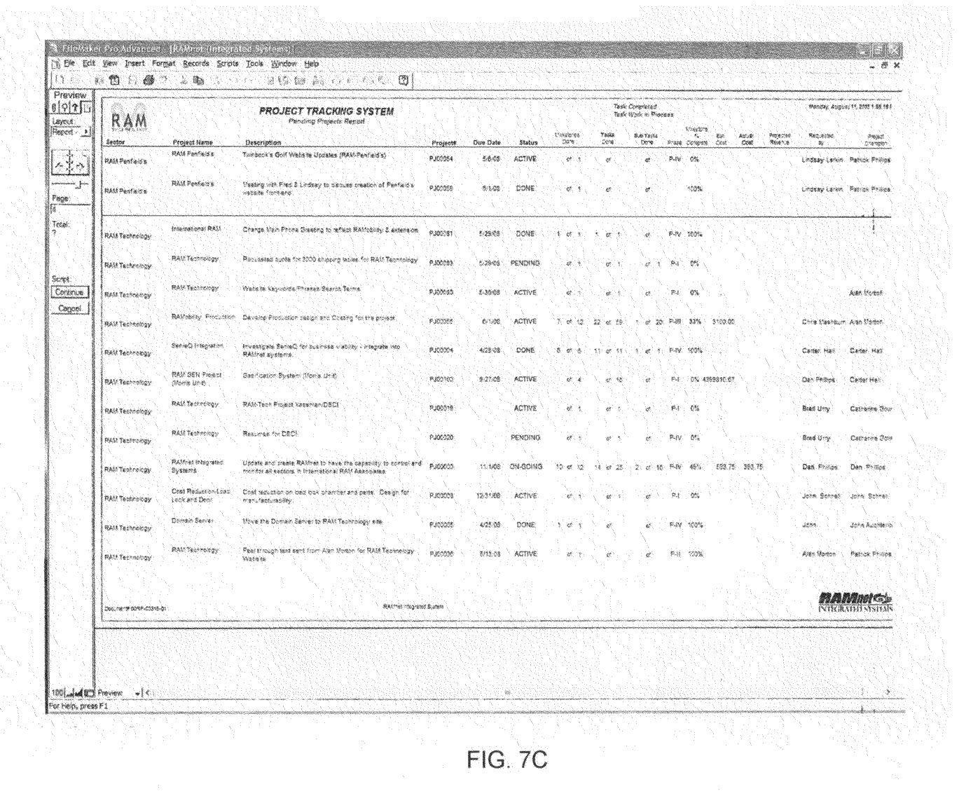

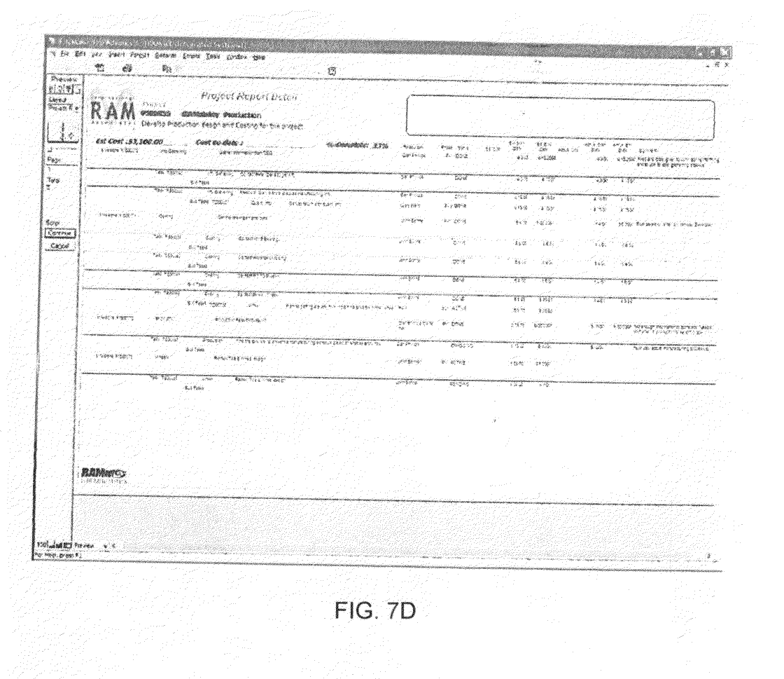

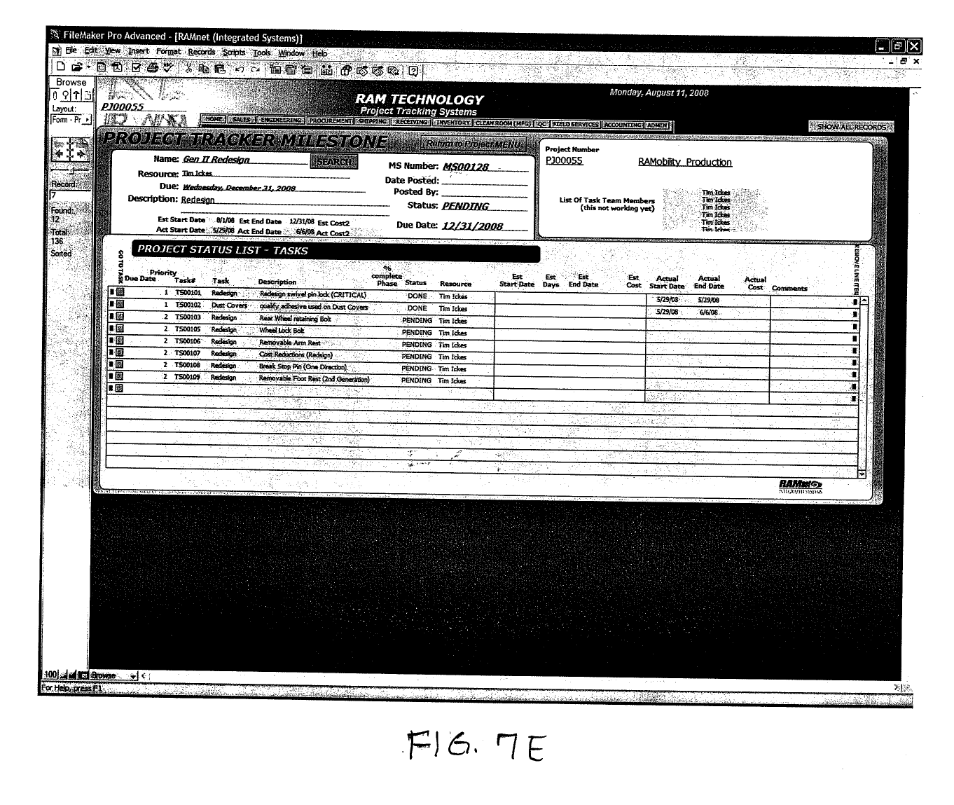

Referring now to FIGS. 7A-7E, the method of the present invention allows business management to conveniently track a substantial number of projects or programs many of which are on-going simultaneously within the organization. FIG. 7A is a top level screen display which identifies not only each project, but also provides a brief description of each project, their completion or due date, their current status, portion of the project completed as of the report date, and the sector of the business with which the project is associated.

Each project has an identified list of milestones and these are shown in FIG. 7B together with the phase of the project with which a milestone is associated, the current status of the milestone's completion, the responsible person or group (Resource), estimated and actual staring and ending dates for each milestone, and relevant comments. As shown in FIGS. 7C and 7D, activities associated with the project are further broken down so to provide management and project personnel a comprehensive status report for each project. This allows any “roadblocks” which exist to be readily identified and their resolution addressed. Finally, FIG. 7E provides, for a project, a status list of the project tasks and their current status.

As with other information used in the system, the program executed by the system requires that information only be entered once, and once in the system is automatically available wherever it is required, regardless of which department needs it. Finally, it is important that the method and the program by which it is implemented are easy to use, that the program is readily customized to each organization's business and method of operation, and that the program is easily learned by personnel at all levels within the organization so to provide maximum flexibility.

What is claimed is:

1. A method of controlling work flow in an organization comprising:
identifying critical information required by each department within the organization for controlling the work flow through that department;
identifying information within each department useful to other departments for controlling the work flow through that department and coordination the work flow through department with the work flow through each of the other departments; and,
providing an information framework by which all the identified information is readily available, as needed, throughout the organization so to facilitate implementation of those work flow activities required of each department to efficiently complete an organizational activity.

2. The method of claim 1 in which the information framework is such that relevant information regardless of where used needs to be entered only once thereby to prevent data entry errors resulting from multiple entries.
